(19) United States
(12) Patent Application Publication
(10) Pub. No.: US 2007/0164676 A1
(43) Pub. Date: Jul. 19, 2007

(54) External electrode lamp, method of manufacturing the same and liquid crystal display apparatus using the same

(76) Inventor: Hyun Jin Kim, Seoul (KR)

Correspondence Address: CANTOR COLBURN, LLP, 55 GRIFFIN ROAD SOUTH, BLOOMFIELD, CT, 06002, US

(21) Appl. No.: 11/654,779

(22) Filed: Jan. 18, 2007

(30) Foreign Application Priority Data
Jan. 18, 2006 (KR) 2006-0005287

(51) Int. Cl. H01J 65/00

(52) U.S. Cl. 313/607

(57) ABSTRACT

An external electrode lamp capable of preventing a lighting defect by easily emitting secondary electron within a lamp tube, a method of manufacturing the external electrode lamp, and a liquid crystal display apparatus using the external electrode lamp. The external electrode lamp includes a lamp tube filled with a discharge gas, an external electrode encompassing both ends of the lamp tube, and a conductive material disposed at an inner surface of the both ends of the lamp tube.

This application claims priority to Korean Patent Application No. 2006-0005287 filed on Jan. 18, 2006, and all the benefits accruing therefrom under 35 U.S.C. §119, the contents of which are hereby incorporated by reference in their entirety.

### BACKGROUND OF THE INVENTION

1. Field of the Invention

The present invention relates to an external electrode lamp, and more particularly, to an external electrode lamp capable of preventing a lighting defect such as low-temperature lighting defect or a dark start-up defect, a method of manufacturing the external electrode lamp, and a liquid crystal display apparatus using the external electrode lamp.

2. Description of the Related Art

A liquid crystal display (LCD) apparatus displays images by using electro-optical properties of liquid crystals. The LCD apparatus includes an LCD panel for displaying images through a pixel matrix and a driving circuit for driving the LCD panel. The LCD apparatus further includes a backlight unit for supplying light from the back of the LCD panel because the LCD panel is a non-emitting device. The LCD panel displays images by adjusting the transmittance of light irradiated from the backlight unit while each subpixel constituting the pixel matrix varies the arrangement of the liquid crystals according to a data signal.

The backlight unit is divided into an edge type and a direct type according to the location of a light source. The edge type has a structure in which the light source is installed at the side of a light guide plate and a side incident light from a lamp is supplied to the LCD panel by diffusing it as a plane light through the light guide plate and a plurality of optical sheets. The direct type is applied to a large-sized LCD panel and has a structure in which a plurality of light sources is arranged with a given distance from the bottom of the LCD panel to supply light to the entire surface of the LCD panel.

A cold cathode fluorescent lamp (CCFL) having a cylindrical shape has been mainly used as the light source of the direct type backlight unit, but recently an external electrode fluorescent lamp (EEFL) of which an electrode is formed at the exterior has emerged. The EEFL uses a lamp tube as a conductor and can be driven in parallel by the lamp itself.

In the EEFL, a discharge of an inert gas sealed within the lamp tube occurs by a high frequency signal applied to an external electrode from an inverter and a fluorescent material formed at the interior of the lamp tube emits light by ultraviolet rays generated by the discharge of gas. At this time, since the EEFL has the electrode formed at the exterior of the lamp tube, secondary electrons, which are the cause of creating plasma, are emitted from the surface of glass within the lamp tube of which work function is low. However, if the EEFL is driven under the poor condition such as low-temperature driving or dark start-up, the secondary electrons within the lamp tube are not easily emitted. Therefore, a light defect such as low-temperature lighting defect or dark start-up defect occurs.

### BRIEF SUMMARY OF THE INVENTION

An exemplary embodiment provides an external electrode lamp capable of preventing a lighting defect by easily emitting secondary electron within a lamp tube, a method of manufacturing the external electrode lamp, and an LCD apparatus using the external electrode lamp.

An exemplary embodiment provides an external electrode lamp including a lamp tube filled with a discharge gas, an external electrode encompassing both ends of the lamp tube, and a conductive material disposed at an inner surface of the both ends of the lamp tube.

In an exemplary embodiment, the conductive material is disposed with a substantially uniform thickness over the whole inner surface of the both ends of the lamp tube or partially formed.

In another exemplary embodiment there is provided a method of manufacturing an external electrode lamp, the method including providing a lamp tube of which both ends are opened, coating an inner surface of an emission region of the lamp tube with a fluorescent material, forming a conductive material at an inner surface of each of both ends of the lamp tube, filling the lamp tube with a discharge gas and sealing the both ends of the lamp tube, and forming an external electrode encompassing the both ends of the lamp tube.

In an exemplary embodiment, the method may further include scattering the conductive material using ultrasonic waves after sealing the both ends of the lamp tube.

In another exemplary embodiment there is provided an LCD apparatus including a lamp assembly, a bottom chassis receiving the lamp assembly therein, an LCD panel arranged over the lamp assembly, a plurality of optical sheets disposed between the LCD panel and the lamp assembly, and a top chassis encompassing a peripheral part of the LCD panel and being locked with the bottom chassis. The lamp assembly includes a plurality of external electrode lamps in which a conductive material is formed at the inner surface of both ends of a lamp tube encompassed by an external electrode, and a circuit board for connecting the plurality of external electrode lamps in parallel.

In an exemplary embodiment, the lamp assembly may further include a lamp holder formed on the circuit board, the external electrode of each of the plurality of external electrode lamps fixedly inserted into the lamp holder and connected to the circuit board through the lamp holder.

### BRIEF DESCRIPTION OF THE DRAWINGS

The above and other features and advantages of the present invention will become more apparent from the following detailed description when taken in conjunction with the accompanying drawings in which:

FIG. 1 is a perspective view illustrating an exemplary embodiment of an EEFL according to the present invention;

FIG. 2 is a cross-sectional view illustrating an exemplary embodiment of a part of the EEFL shown in FIG. 1;

FIG. 3 is a cross-sectional view illustrating another exemplary embodiment of a part of an EEFL according to the present invention; and

FIG. 4 is an exemplary embodiment of an exploded perspective view of an LCD apparatus using an EEFL according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

Spatially relative terms, such as “lower” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

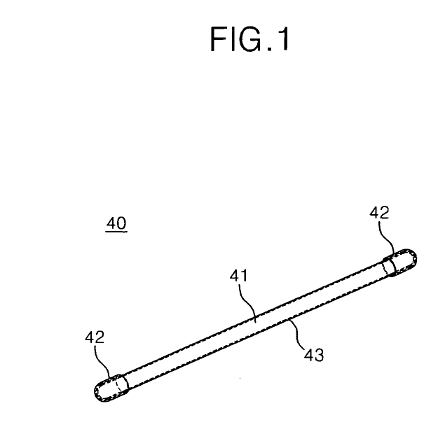

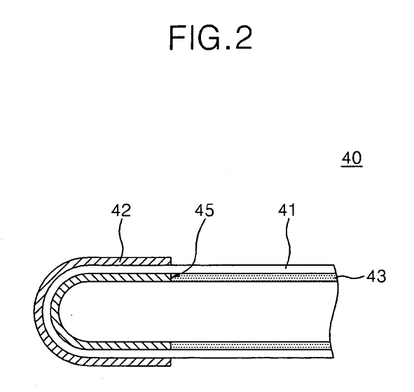

The exemplary embodiments of the present invention will now be described with reference to the attached drawings. FIG. 1 is a perspective view illustrating an exemplary embodiment of an EEFL according to the present invention, and FIG. 2 is a cross-sectional view illustrating an exemplary embodiment of a part of the EEFL shown in FIG. 1.

An light source 40, such as an EEFL shown in FIGS. 1 and 2, includes a lamp tube 41 for emitting light by plasma emission, external electrodes 42 formed at the exterior of both ends of the lamp tube 41, and an internal conductive layer 45 formed at the interior, such as on an interior surface, at the both ends of the lamp tube 41.

In exemplary embodiments, the lamp tube 41 may be formed such that a thin, long cylindrical glass tube is filled with a discharge gas, including, but not limited to, an inert gas and/or mercury. The inner surface of the lamp tube 41 is coated with a fluorescent layer 43. An emission region of the lamp tube 41 is coated with the fluorescent layer 43. The emission region is considered being between non-emission regions blocked by the external electrodes 42 of the both ends of the lamp tube 41. In an exemplary embodiment, the fluorescent layer 43 may be formed by depositing a fluorescent powder at the inner wall of the lamp tube 41 of which both ends are not sealed.

The internal conductive layer 45 is formed at the inner surface of the both ends of the lamp tube 41 and facilitates secondary electron emission, which causes the generation of plasma. In an exemplary embodiment, the internal conductive layer 45 may be formed with a conductive material applied in a substantially uniform thickness at the non-emission region blocked by the external electrodes 42 and contacting the fluorescent layer 43 formed at the emission region. The conductive layer 45 contacting of with the fluorescent layer 43 essentially forms a boundary with the fluorescent layer 43.

In an alternative exemplary embodiment, the internal conductive layer 45 may be formed at a part of the both ends of the lamp tube 41. The internal conductive layer 45 may be formed such that after the fluorescent layer 43 is formed at the inner surface of the emission region of the lamp tube 41 of which both ends are initially not sealed. The inner surface of the both ends of the lamp tube 41 is coated with a conductive material, and the both ends of the lamp tube 41 are heated and ultimately sealed. The internal conductive layer 45 may be formed by coating the inner surface of the both ends of the lamp tube 41 with a conductive paste, or depositing a conductive material by a deposition method such as sputtering.

In an alternative exemplary embodiment, the internal conductive layer 45 may be formed by scattering a conductive material over the ends of the lamp 41 while rotating the lamp tube 41, or dipping the ends of the lamp tube 41 into a melted lead container. A metal material facilitating secondary electron emission with low work function, such as molybdenum (Mo), tungsten (W), cesium (Cs), etc., may be used as the internal conductive layer 45. But generally metal have lower work function than glass, so most metal may be used as the internal conductive layer 45. In exemplary embodiments, the internal conductive layer 45 is formed with a thin thickness of about 1 μm.

The external electrode 42 is formed to encompass the both ends of the sealed lamp tube 41. In exemplary embodiments, the external electrode 42 may be attached to the both ends of the lamp tube 41 in a conductive cap shape, or attached to the both ends of the lamp tube 41 in a metal tape shape. The external electrode 42 may also be formed by depositing a metal layer by a deposition method such as sputtering or by dipping the ends of the sealed lamp tube 41 into the melted lead container.

If a high frequency signal is applied from the inverter to the external electrode 42 of the EEFL 40, plasma is generated from the interior of the lamp tube 41 by a gas discharge and the fluorescent layer 43 emits light by ultraviolet rays generated by the gas discharge. Plasma collides with the internal conductive layer 45 formed at the inner surface of the both ends of the lamp tube 41 encompassed by the external electrode 42. Advantageously, the second electron emission is facilitated and a lighting defect such as low-temperature lighting defect or dark start-up defect can be reduced or effectively prevented.

An exemplary embodiment of a method of manufacturing the EEFL 40 shown in FIGS. 1 and 2 will now be described.

A thin, long cylindrical glass tube of which both ends are opened is used as the lamp tube 41. The fluorescent layer 43 is formed by depositing a fluorescent powder at the inner surface of the emission region of the lamp tube 41. The internal conductive layer 45 is formed at the inner surface of the non-emission region of the both ends of the lamp tube 41.

In an exemplary embodiment, the internal conductive layer 45 may be formed by any of a number of suitable processes, such as coating the inner surface of the both ends of the lamp tube 41 with a conductive paste, depositing a conductive material by sputtering, scattering a conductive material over the ends of the lamp tube 41 while rotating the lamp tube 41 or dipping the ends of the lamp tube 41 into a melted lead container.

The both ends of the lamp tube 41 in which the internal conductive layer 45 is formed are heated and sealed. The lamp tube 41 is sealed under a discharge gas atmosphere and it is filled with a discharge gas before sealed.

The external electrodes 42 encompassing the exterior of the both ends of the lamp tube 41 are formed. In an exemplary embodiment, the external electrodes 42 may be formed by inserting the both ends of the lamp tube 41 into the electrodes 42 and attaching the electrodes 42 to the lamp tube 41. The electrodes 42 may be attached to the lamp tube 41 in the form of a conductive cap, in the form of a metal tape, by depositing a metal layer by a deposition method such as sputtering, or by dipping the ends of the sealed lamp tube 41 into the melted lead container.

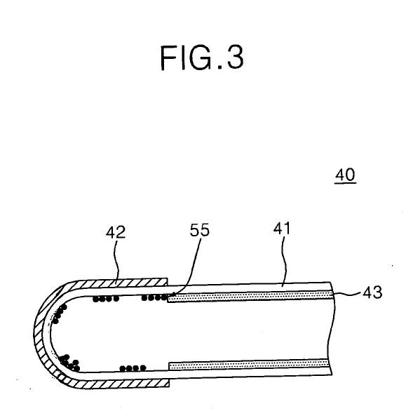

FIG. 3 is a cross-sectional view illustrating another exemplary embodiment of a part of an EEFL according to the present invention. The EEFL 40 shown in FIG. 3 includes irregularly scattered internal conductive particles 55 instead of the internal metal layer 45 shown in FIG. 2 and therefore a description of the repetitive constituent elements and manufacturing method thereof will be omitted.

The internal conductive particles 55 shown in FIG. 3 are scattered over the inner surface of the both ends of the lamp tube 41 to facilitate the secondary electron emission that causes the generation plasma. The internal conductive particles 55 are irregularly scattered over the inner surface of the both ends of the lamp tube 41 encompassed by the external electrode 42.

In an exemplary embodiment, the internal conductive particles 55 may be formed by irregularly scattering conductive particles over the inner surface of the both ends of the lamp tube 41 and by heating and sealing the both ends of the lamp tube 41 after the fluorescent layer 43 is formed at the inner surface of the emission region of the lamp tube 41 when both ends are not sealed. In an exemplary embodiment, the internal conductive particles 55 may be formed by injecting the conductive particles into the both ends of the lamp tube 41, heating and sealing the both ends of the lamp tube 41 and breaking the conductive particles injected into the both ends of the lamp tube 41 by ultrasonic vibration so as to be attached to the inner surface of the lamp tube 41.

When the high frequency signal is applied from the inverter to the external electrode 42 of the EEFL 40, plasma is generated from the interior of the lamp tube 41 by a gas discharge and the fluorescent layer 43 emits light by ultraviolet rays generated by the gas discharge. The conductive particles 55 scattered irregularly over the inner surface of the lamp tube 41 encompassed by the external electrode 42 collide with the plasma, resulting in facilitating the secondary electron emission. Advantageously, a lighting defect such as low-temperature lighting defect or dark start-up defect is reduced or effectively prevented.

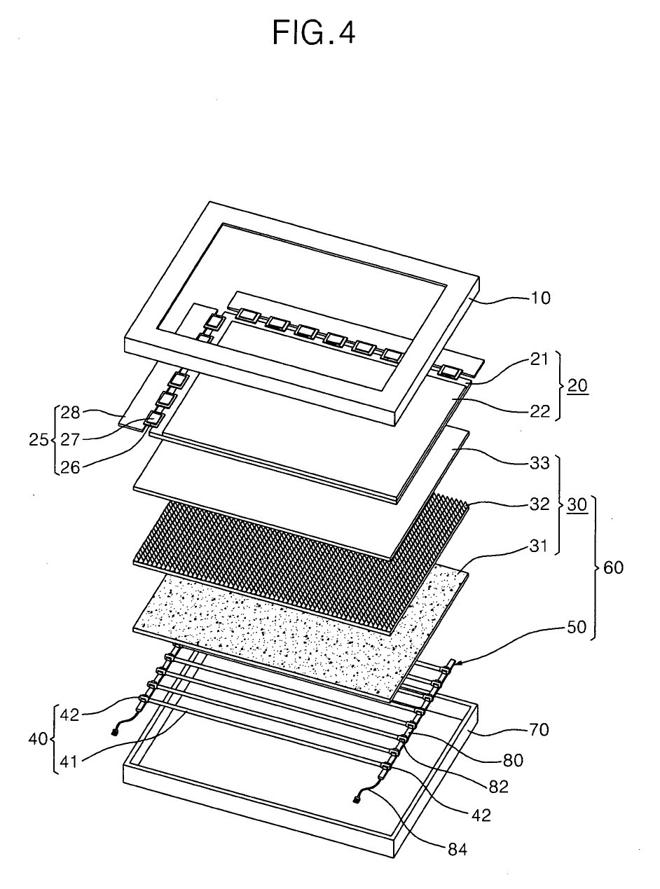

FIG. 4 is an exploded perspective view of an exemplary embodiment of an LCD apparatus using the EEFL 40 according to the present invention.

The LCD apparatus shown in FIG. 4 includes an LCD panel 20, a backlight unit 60, such as a direct type backlight unit, for supplying light to the back of the LCD panel 20 and a top chassis 10 and a bottom chassis 70 for receiving the LCD panel 20 and the backlight unit 60 therein.

The bottom chassis 70 receives the backlight unit 60 and the LCD panel 20 is disposed on the backlight unit 60 with a predetermined distance therebetween. The LCD panel 20 and the backlight unit 60 are fixed and protected by the top chassis 10 locked with the bottom chassis 70. An opening for exposing an image display region of the LCD panel 20 is provided at the upper surface of the top chassis 10. A mold frame (not shown) for mounting the LCD panel 20 and as optical member 30, such as a plurality of optical sheets, contained in the backlight unit 60 may be further provided at an internal space generated by locking the bottom chassis 70 with the top chassis 10.

The LCD panel 20 includes an upper substrate 22 and a lower substrate 21 are assembled with liquid crystals disposed therebetween. The upper substrate 22 may include color filters formed thereon. The lower substrate may include thin film transistors (TFTs) formed thereon. The LCD panel 20 displays images by adjusting the transmittance of light in such a manner that subpixels driven independently by the TFTs are arrayed in a matrix form. The respective subpixels control the arrangement of liquid crystals according to a difference voltage between a common voltage supplied to a common electrode and a data signal supplied through the TFTs to a pixel electrode. Since the LCD panel 20 is a non-emitting device, light generated from the backlight unit 60 is used.

A driver 25 is connected to the lower substrate 21 of the LCD panel 20. The driver 25 includes a plurality of film circuits 26 each including a driving chip 27 mounted thereon to drive a data line and a gate line of the LCD panel 20. The film circuits 26 includes one side connected to the lower substrate 21 and a printed circuit board (PCB) 28 connected to another side. The film circuits 26 including the driving chip 27 thereon as illustrated in FIG. 4 may be a chip-on-film (COF) or tape carrier package (TCP) type. In an alternative exemplary embodiment, the driving chip 27 may be directly mounted on the lower substrate 21 by chip-on-glass (COG) or may be mounted on the lower substrate 21 during a process of forming the TFTs.

The backlight unit 60 includes a light source 50, such as a lamp assembly, including a plurality of EEFLs 40 and a fixing member 80. The backlight unit 60 also includes a plurality of optical sheets 30 arranged between the LCD panel 20 and the lamp assembly 50 to raise light efficiency. The fixing member 80 fixes both sides of each of the EEFLs 40 and connects the EEFLs 40 in parallel. In an exemplary embodiment, the fixing member 80 may be a circuit board.

The optical member 30 may include a diffusion sheet 31, a prism sheet 32 and a protection sheet 33. The diffusion sheet 31 may include a base film and a coating layer, including but not limited to, a bead, formed at the base film. The diffusion sheet 31 makes luminance uniform by diffusing light supplied from the lamp assembly 40. The prism sheet 32 may have a structure in which a plurality of a triangular prism is uniformly arranged on its upper surface. The prism sheet 32 serves as collecting light diffused from the diffusion sheet 31 in substantially the vertical direction with respect to the back of the LCD panel 20. The prism sheet 32 may include two prism sheets and micro-prisms formed at the respective prism sheets cross at given angles. Essentially all of the light passing through the prism sheet 32 travels vertically to provide uniform luminance distribution. In alternative exemplary embodiments, a reflective polarized sheet may be used together with the prism sheet 32, or only the reflective polarized sheet may be used without the prism sheet 32. The protection sheet 33 protects the prism sheet 32 which is subject to scratching or damage.

The lamp assembly 50 illustrated in FIG. 4 includes a plurality of EEFLs 40 and two circuit boards 80 as the fixing member. The circuit boards 80 include clip-type lamp holders 82 into which external electrodes 42 of the both ends of each of the EEFLs 40 are inserted and fixed. Each of the EEFLs 40 may include the internal metal layer 45 formed at the inner surface of the both ends of the lamp tube 41 as shown in FIG. 2 or the conductive particles 55 scattered irregularly over the inner surface of the both ends of the lamp tube 41 as shown in FIG. 3, thereby facilitating the secondary electron emission. Accordingly, a lighting defect is prevented. The external electrodes 42 of each of the EEFLs 40 are inserted into and fixed to the lamp holder 82 formed on the circuit boards 80. The external electrodes 42 of the EEFLs 40 are connected in parallel through the lamp holders 82 of a conductive material and wirings of the circuit boards 80.

A connection member 84, such as a lamp wiring, connected to a circuit board on which an external inverter (not shown) is mounted are connected to the circuit boards 80. Advantageously, one inverter may drive the plurality of EEFLs 40 simultaneously by commonly supplying a high frequency signal to the external electrodes 42 of the plurality of EEFLs 40 through the lamp wirings 84 and the circuit boards 80.

The inner surface of the bottom chassis 70 receiving the lamp assembly may be formed of a reflective surface coated with a reflective material for reflecting light from the lamp assembly 50 toward the diffusion sheet 31. In an exemplary embodiment, the reflective surface may be coated with a reflective material such as polyethylene terephthalate (PET), polycarbonate (PC), silver, aluminum, etc.

As described above, the external electrode lamp according to the present invention facilitates the secondary electron emission during plasma emission by forming the internal conductive layer or internal conductive particles at the inner surface of the both ends of the lamp tube encompassed by the external electrode. Therefore, a lighting defect such as low-temperature lighting or dark start-up can be prevented. Moreover, since the LCD apparatus using the external electrode lamp according to the present invention prevents the lighting defect, deterioration of reliability caused by the lighting defect can be prevented.

While the invention has been shown and described with reference to the particular embodiments thereof, it will be understood by those skilled in the art that various changes in form and details may be made therein without departing from the spirit and scope of the invention as defined by the appended claims.

1. An external electrode lamp, comprising:
a lamp tube filled with a discharge gas;
an external electrode encompassing at least one end of the lamp tube; and
a conductive material disposed at an inner surface of at least one end of the lamp tube.

2. The external electrode lamp as set forth in claim 1, wherein the conductive material is Mo, W or Cs.

3. The external electrode lamp as set forth in claim 1, further comprising a fluorescent layer disposed at an inner surface between both ends of the lamp tube.

4. The external electrode lamp as set forth in claim 3, wherein the conductive material is disposed with a substantially uniform thickness over the whole inner surface of the both ends of the lamp tube.

5. The external electrode lamp as set forth in claim 3, wherein the conductive material is disposed over a portion of the inner surface of the both ends of the lamp tube.

6. The external electrode lamp as set forth in claim 3, wherein the conductive material is irregularly scattered over the internal surface of the both ends of the lamp tube.

7. A method of manufacturing an external electrode lamp, the method comprising:
providing a lamp tube of which both ends are opened;
coating an inner surface of an emission region of the lamp tube with a fluorescent material;
forming a conductive material at an inner surface of at least one end of the lamp tube;
filling the lamp tube with a discharge gas and sealing the both ends of the lamp tube; and
forming an external electrode encompassing at least one end of the lamp tube.

8. The method as set forth in claim 7, wherein the conductive material is Mo, W or Cs.

9. The method as set forth in claim 7, wherein the forming a conductive material comprises forming the conductive material in a substantially uniform thickness over the whole inner surface of the both ends of the lamp tube.

10. The method as set forth in claim 9, wherein the conductive layer contacts the fluorescent layer and forms a boundary between the conductive layer and the fluorescent layer.

11. The method as set forth in claim 7, wherein the forming a conductive material comprises forming the conductive material over a portion of the inner surface of the both ends of the lamp tube.

12. The method as set forth in claim 7, wherein the forming a conductive material comprises irregularly scattering the conductive material over the internal surface of the both ends of the lamp tube.

13. The method as set forth in claim 12, wherein the forming a conductive material further comprises scattering the conductive material using ultrasonic waves after sealing the both ends of the lamp tube.

14. A liquid crystal display apparatus, comprising:
a lamp assembly including a plurality of external electrode lamps in which a conductive material is formed at an inner surface of at least one end of the lamp tube, at least one end of the lamp encompassed by an external electrode, and a circuit board connecting the plurality of external electrode lamps in parallel;
a bottom chassis receiving the lamp assembly therein;
a liquid crystal display panel arranged over the lamp assembly;
a plurality of optical sheets disposed between the liquid crystal display panel and the lamp assembly; and
a top chassis encompassing a peripheral part of the liquid crystal display panel and being locked with the bottom chassis.

15. The liquid crystal display apparatus as set forth in claim 14, wherein the conductive material is Mo, W or Cs.

16. The liquid crystal display apparatus as set forth in claim 14, wherein a fluorescent layer is disposed at an inner surface between both ends of the lamp tube.

17. The liquid crystal display apparatus as set forth in claim 16, wherein the conductive material is formed with a substantially uniform thickness over the whole inner surface of the both ends of the lamp tube.

18. The liquid crystal display apparatus as set forth in claim 16, wherein the conductive material is formed over a portion of the inner surface of the both ends of the lamp tube.

19. The liquid crystal display apparatus as set forth in claim 16, wherein the conductive material is irregularly scattered over the internal surface of the both ends of the lamp tube.

20. The liquid crystal display apparatus as set forth in claim 14, wherein the lamp assembly further includes a lamp holder formed on the circuit board, the external electrode of each of the plurality of external electrode lamps being fixedly inserted into the lamp holder and connected to the circuit board through the lamp holder.
